(19) United States
(12) Patent Application Publication
(10) Pub. No.: US 2017/0036921 A1
(43) Pub. Date: Feb. 9, 2017

(54) PORTABLE WATER FEEDER

(71) Applicant: James-Roy OUELLETTE, Ontario (CA)

(72) Inventor: James-Roy OUELLETTE, Ontario (CA)

(21) Appl. No.: 15/227,374

(22) Filed: Aug. 3, 2016

(30) Foreign Application Priority Data
Aug. 3, 2015 (CA) 2899632

(51) Int. Cl. C02F 1/00; A01K 53/00; A01K 39/02; A01K 7/00; A01K 45/00; B01D 35/02; A01G 25/00

(52) U.S. Cl. CPC C02F 1/001; B01D 35/02; A01K 53/00; A01G 25/00; A01K 7/00; A01K 45/002; A01K 39/02; C02F 2103/001

(57) ABSTRACT

A portable water feeder for collecting rain water for bees, butterflies and many other uses has a vessel in which rain water is collected. A filter removes impurities from the rain water and a wind-powered agitator maintains the water in motion to minimize the build-up of algae. A valve controls the quantity of water which flows from the vessel to a watering station where the water is available for use.

### FIELD OF THE INVENTION

This invention relates to a waterfeeder and more particularly to a gravity-fed water feeder which provides a source of water in the out-of-doors without the necessity of an external source of power to operate.

### CROSS-REFERENCE TO RELATED PRIOR APPLICATION

This application claims priority pursuant to 35 USC 119 of Canadian application no. 2,899,632 filed in the Canadian Intellectual Property Office on Aug. 3, 2015, which application is incorporation into this application by reference.

### BACKGROUND OF THE INVENTION

Honey bees require clean water not only to drink but also to cool the hive; and to add to the honey that they are producing to maintain a proper moisture content. In a commercial bee-keeping operation water is usually provided to bees in trays. The level of water in the trays must be limited because if the level is too high, the bees may drown in it. In hot weather, water in the trays, being relatively limited, evaporates rapidly and soon the trays become thy unless the water is replenished. The task of replenishing the water to the trays frequently must be carried out daily. For this reason the provision of water to bees can be highly labour intensive.

I have invented a water feeder which is supplied with water from rain and, in a dry spell, may be filled by hand. The feeder is gravity-fed and has no external source of power to function. The feeder has many advantages: the feeder is a portable so that it can be placed near a hive, on a flat roof, or in a back yard in an urban area where it can be placed close enough to a hive that bees will be encouraged to select it as a source of water and not a neighbouring swimming pool or a fountain in a park where humans may be stung by the bees. A further advantage of my feeder is that the water which is available to bees is in amounts controlled by a valve such as a float valve. The amounts are sufficient to feed to the bees but not so much that they may drown in it. The risk of drowning is accordingly minimized no matter how much water is added to the feeder by rain or by hand.

A feature of my water feeder is that water in the feeder is kept in motion by a wind-powered agitator, or battery-driven when the wind is not strong enough to activate the agitator, to reduce the build-up of algae. Preferably in addition to the agitator, there is also means for causing water to cascade through the water feeder to supplement the action of the agitator for keeping the water in motion.

Not only is my feeder particularly suitable for supplying water to honey bees but it is also suitable as a source of water to other insects such as butterflies and bumble bees and as a source of water for bird-baths, drinking stations for animals and even for irrigating plants such as vegetables and flowers.

### SUMMARY OF THE INVENTION

Briefly the water feeder of my invention includes: a collector for rain water; a filter for removing impurities from the rain water so collected to provide filtered water; a vessel for holding the filtered water; an agitator for maintaining the filtered water in motion; a watering station to which the filtered water flows from said vessel; and a valve for controlling the quantity of water which flows from said vessel to said watering station.

### DESCRIPTION OF THE DRAWINGS

The water feeder of the invention is illustrated in the drawings in which:

FIG. 1a is an elevation of the upper half of the water feeder;

FIG. 1b is an elevation of the lower half of the water feeder;

FIG. 2a is a perspective view of an agitator for keeping water in motion in a vessel of the water feeder;

FIG. 2b is a plan view of the upper portion of the agitator;

FIG. 3 are two elevations of the upper vessel of the water feeder, one illustrating a screen for filtering water and the other, means for attaching to an intermediate vessel beneath the upper vessel;

FIG. 4a is a plan view of an intermediate vessel of the water feeder;

FIG. 4b is an exploded perspective view of a float within the water feeder;

FIGS. 5a and 5b are elevations of the float in a vessel beneath the intermediate vessel. In FIG. 5a the float is in a higher level and in FIG. 5b the float is in a lower level; and

FIG. 6 is a perspective view, partly cut away, of the vessel for the float and a tray which functions as a watering station.

Like reference characters refer to like parts throughout the description of the drawings.

### DESCRIPTION OF THE PREFERRED EMBODIMENT

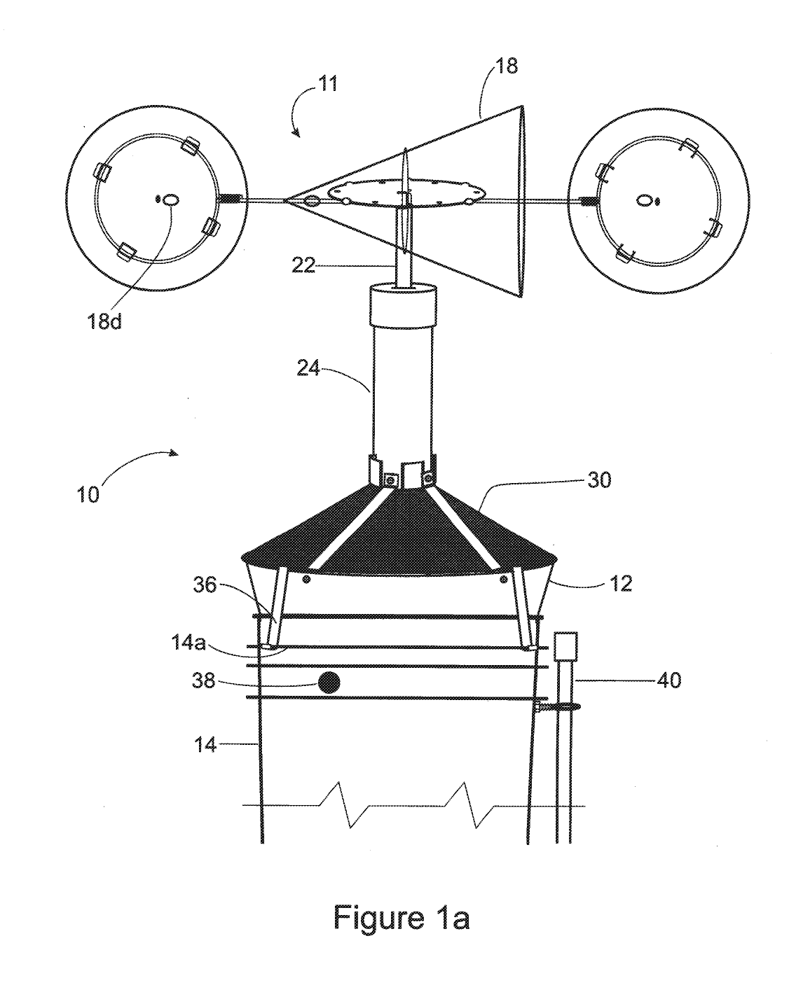

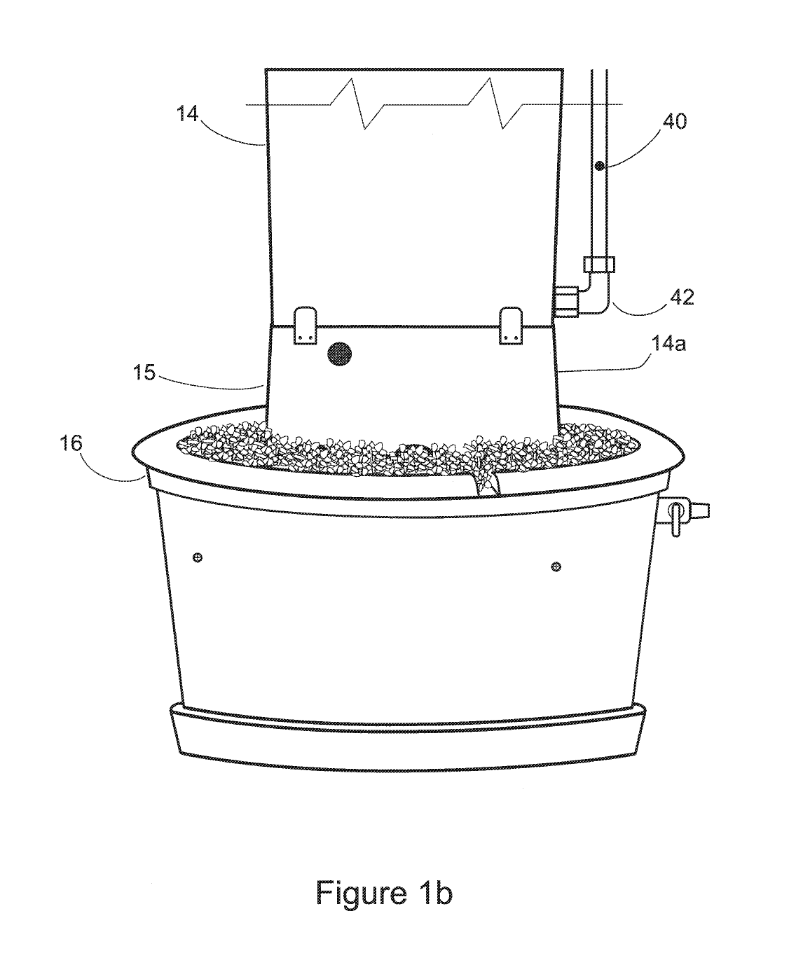

With reference to FIGS. 1a and 1b, the water feeder of the invention, generally 10, comprises an array of cones, generally 11, at the top of the water feeder. Beneath the cones is a first or upper vessel 12, a second or intermediate vessel 14 beneath the upper vessel, a third vessel 15 for a float beneath the intermediate vessel and a tray or watering station 16 which forms the base of the water feeder. The four vessels and the tray or watering station are all in liquid-flow communication with each other and water cascades through each of the vessels entering the first vessel 12 and exiting from tray 16.

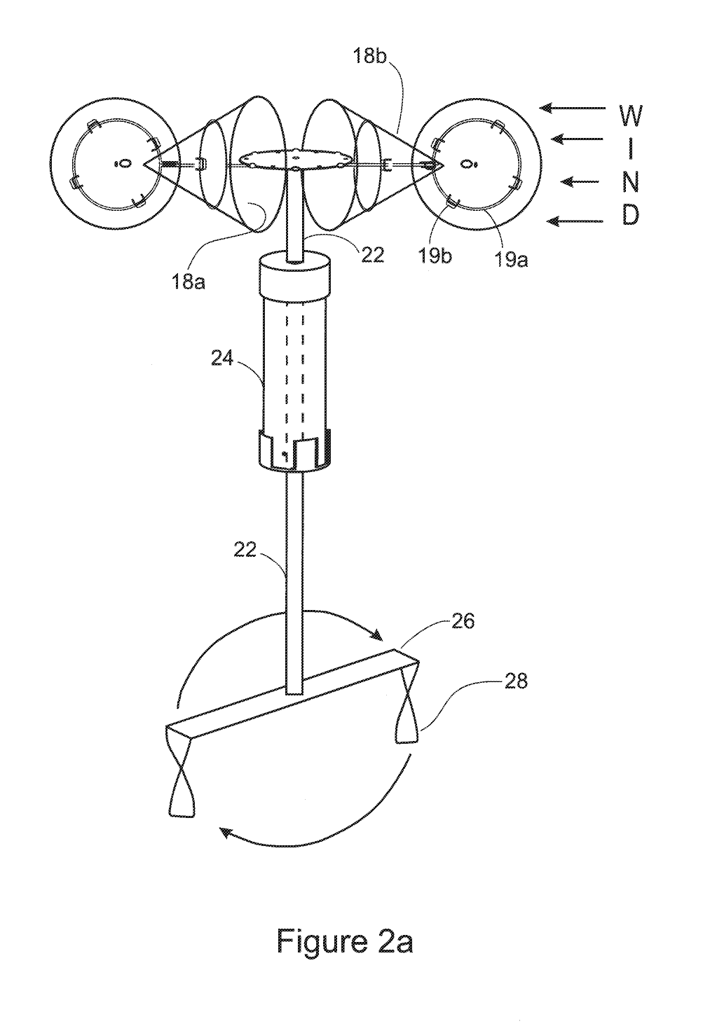

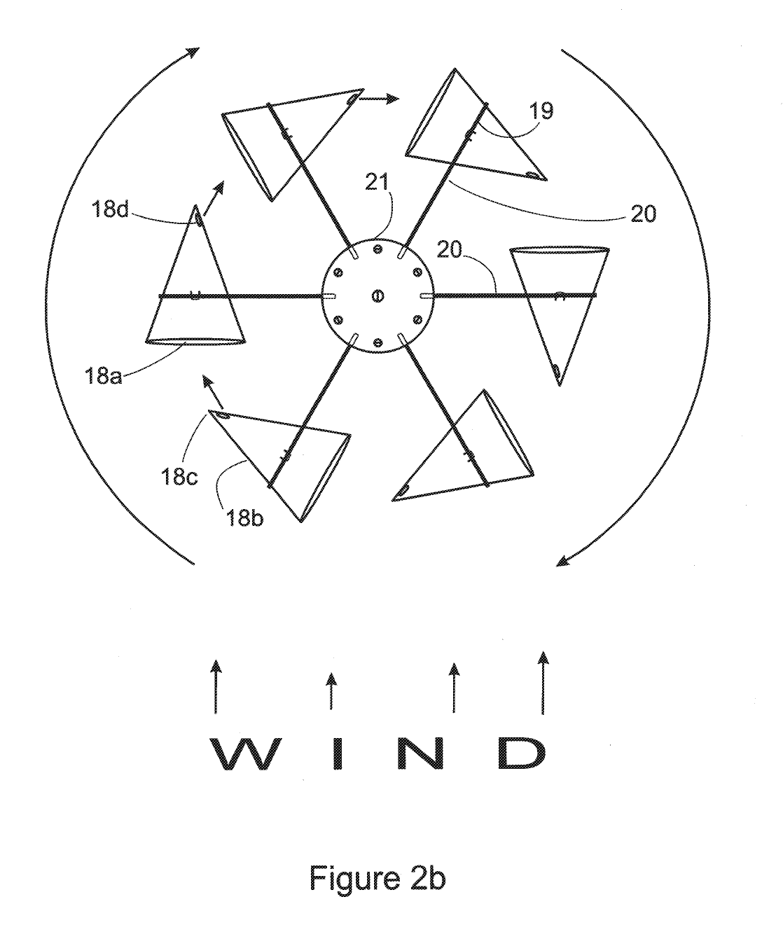

With reference to FIGS. 2a, b, each cone 18a, b in the array is attached by means of a ring 19a and a staple 19b to a separate arm 20 which extends radially outward from a circular plate 21 attached to a central shaft 22. The cones are hollow and have an open circular base 18a, a side wall 18b which tapers to an end 18c. A small aperture 18d is formed in the cone adjacent to end 18c through which the air from the wind exits. The cones function to catch the wind which strikes the water feeder and cause shaft 22 to rotate.

Shaft 22 is mounted in bearings within a housing 24 to rotate about a vertical axis. The shaft extends downward from the array of cones and terminates at a horizontally extending bar 26 within the intermediate vessel 14. Paddies or vanes 28 are attached to opposite ends of the bar and function to keep the water within the vessel in motion.

The cones and paddles constitute an agitator and function to minimize the growth of algae in the water. Wind may be the prime mover for the agitator but other means may be employed for that purpose. For example a battery activated motor may serve to activate the agitator when the wind is too weak to do so.

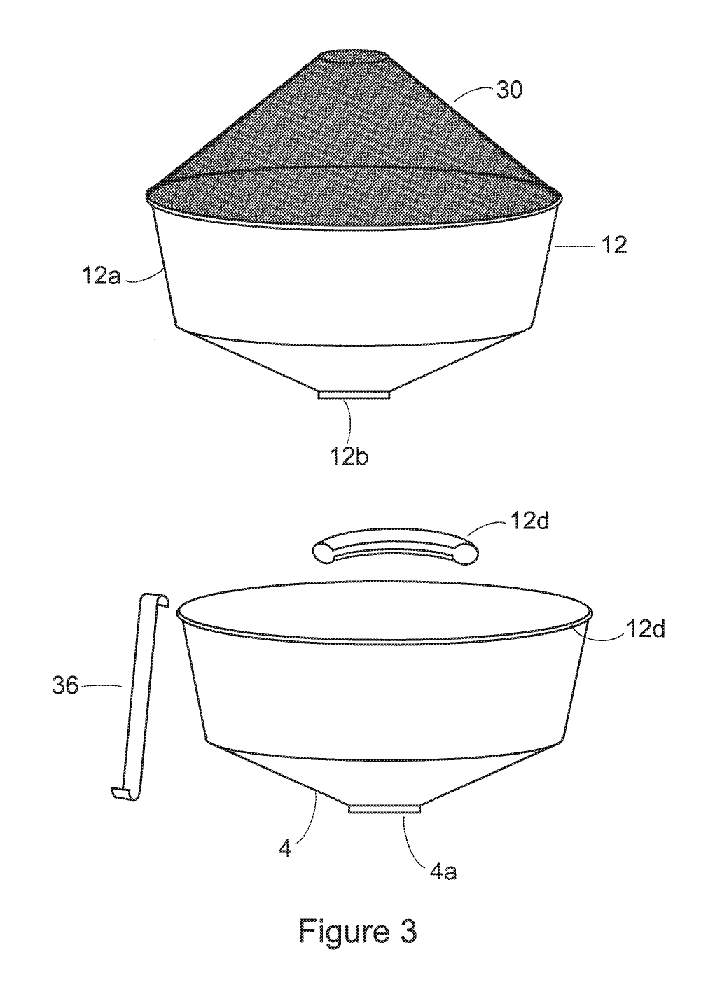

With reference to FIGS. 1a and 3, the upper vessel 12 has a cone shaped or frustum shaped upper wall 30 which tapers upwardly and terminates at housing 24. The upper wall is in the form of a screen for admitting water from rain or from other sources such as municipal water or a well. The screen also serves both to prevent insects from entering the vessel and to minimize the amount of dust in the air from entering the vessel. Because of the shape of the cone, less water evaporates from the vessel than would be the case if it were flat. The cone-shape also functions to catch rain water which the wind causes to flow in various directions over the upper wall such as horizontally, vertically and obliquely.

The side wall 12a of the upper vessel is solid and tapers downward to a central orifice or opening 12b through which water flows downward into the intermediate vessel 14. The upper and intermediate vessels 12, 14 are interconnected by straps 36 which are connected at its upper end to a rim 12d on the upper vessel and on its lower end to a flange 14a on the intermediate vessel.

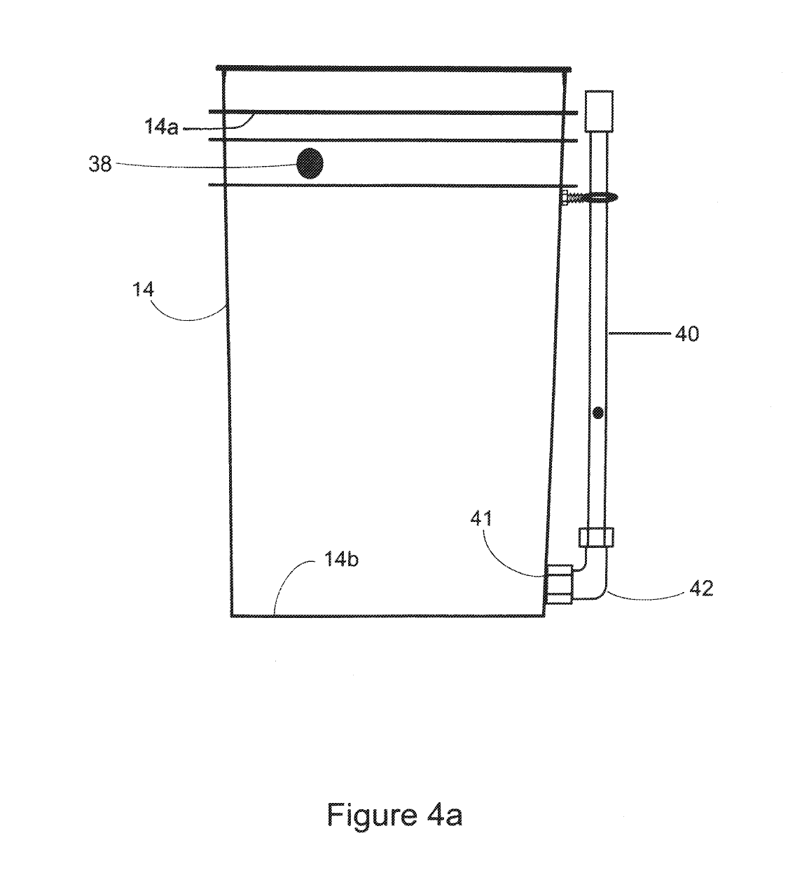

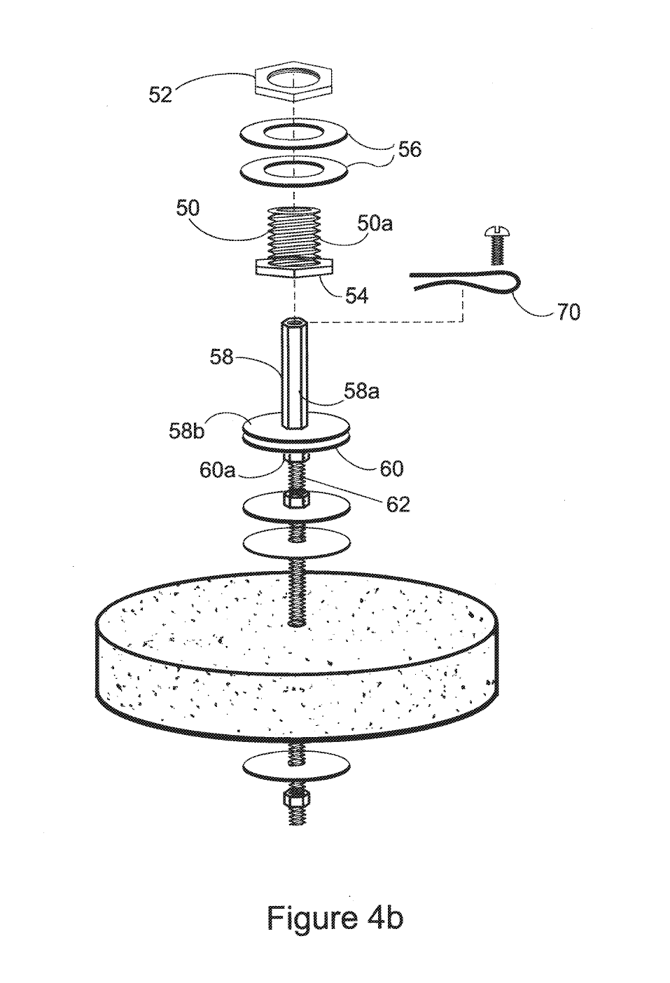

With reference to FIG. 4a, the level of the water within the vessel can be determined by a conventional transparent graduated tube 40 which is spaced apart from the vessel and extends its height. Water flows into the tube through an opening and an elbow 42 near the bottom the vessel. tWxcess watr in the vessel is drained off through overflow port 38.

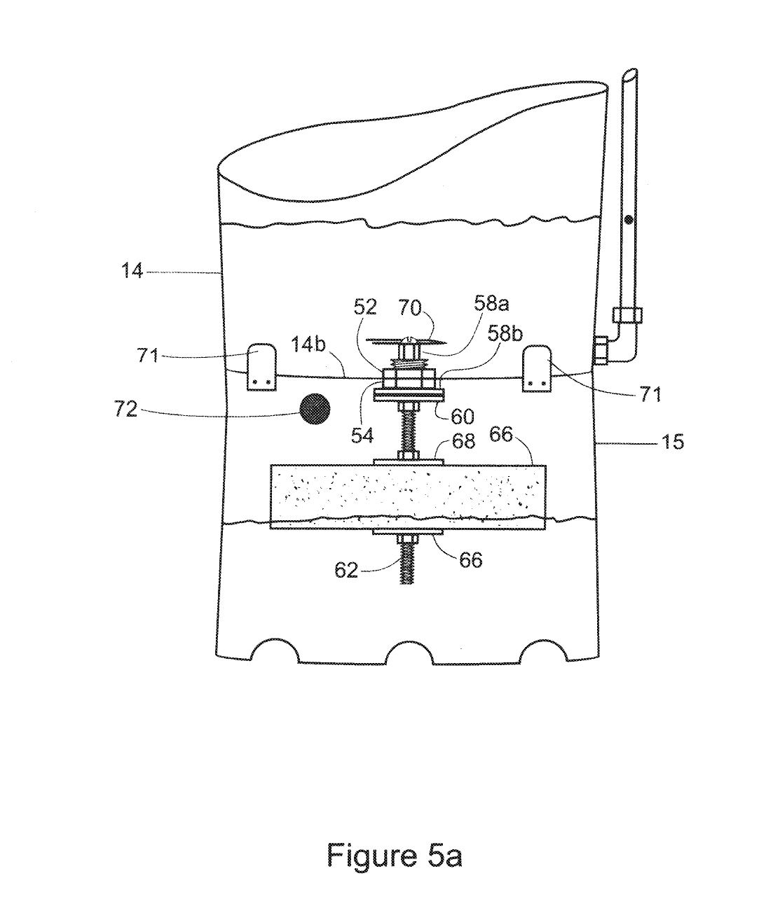

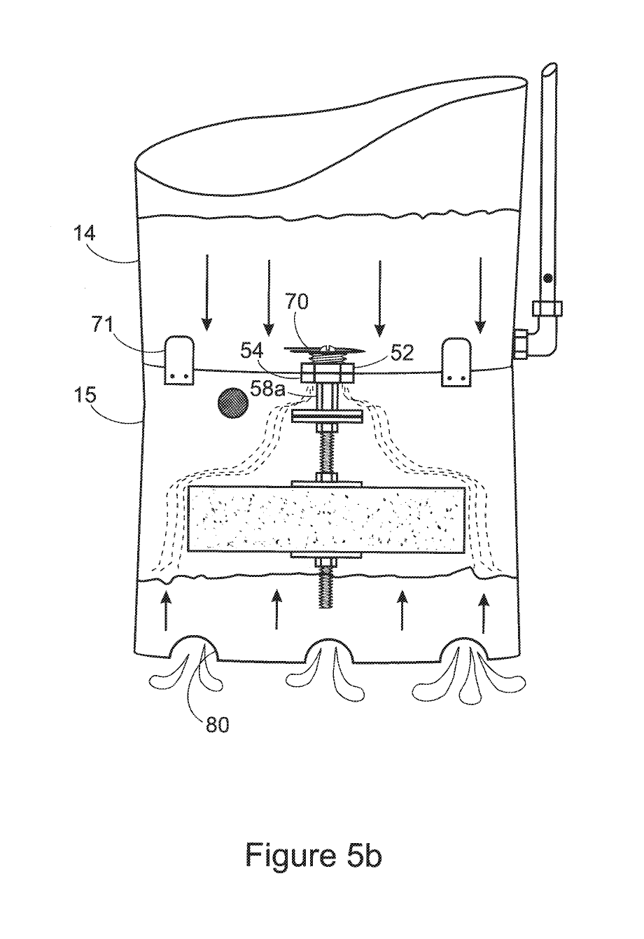

With reference to FIGS. 4b and 5a, beneath the intermediate vessel is the float-containing vessel 15. The two vessels are interconnected by tabs 71 which are attached to vessel 15 and frictionally engage vessel 14. The bottom wall 14b of the intermediate vessel is solid but for a central orifice through which water discharges into the vessel 15. The quantity of water which discharges is controlled by a float valve assembly which includes a water inlet tube 50 having a threaded stem 50a and a hexagonal nut 54 at its lower end. The stern extends through the orifice and is immobilized by an upper hexagonal nut 52. Both nuts 52 and 54 are threadably attached to the stern and are tightened together to ensure that the inlet tube is secured to wall bottom 14b. Gaskets or washers 56 minimizes leakage of water around the edges of the nuts.

Beneath the inlet tube is a valve guide 58 which is provided with a number of longitudinal ribs or tongues 58a which are slidingly received in the cylindrical central inner hollow in inlet tube 50, At the bottom of the valve guide is a circular base 58b which contacts a like shaped valve support 60. The support has a downwardly extending stem 60a which is internally threaded for receipt of a threaded adjustment rod 62.

The adjustment rod extends downwardly and through a central opening in a float 66. The float is sandwiched between lower and upper plates 67, 68 respectively which are threadably attached to the adjustment rod.

In operation, and with reference to FIGS. 5a and 5b, the level of water in the float-containing vessel 15 measures the level of the float. In FIG. 5a, the float is at the maximum elevation. At that elevation, the base 58b of the valve guide is in contact with hex nut 54 and no further upward movement of the float is possible. As the level of water in vessel 15 recedes, the float likewise descends with resulting downward sliding of the ribbed area of the valve guide in the central hollow of the inlet tube. Downward movement of the float ends when clip 70 contacts the top of the valve guide.

Since the central hollow in the inlet tube is cylindrical and the valve guide is ribbed, there is space between the ribs for water to flow downwardly from the intermediate vessel 14 into the float-containing vessel 15. The water continues to flow until the water in the vessel 15 supports the float sufficiently to bring the base 58b of the valve guide into contact with hex nut 54.

To summarize, in FIG. 5a the valve is closed and no water discharges from vessel 14 while in FIG. 5b, the valve is open and water discharges into vessel 15.

By means of adjustment rod 62, the position of the valve guide and the float on the adjustment rod can be adjusted by rotating the backing plate 60 or the lower and upper plates 67, 68 respectively on the rod with resulting adjustment in the maximum level of water within the vessel. An overflow port 72 is provided in vessel 15.

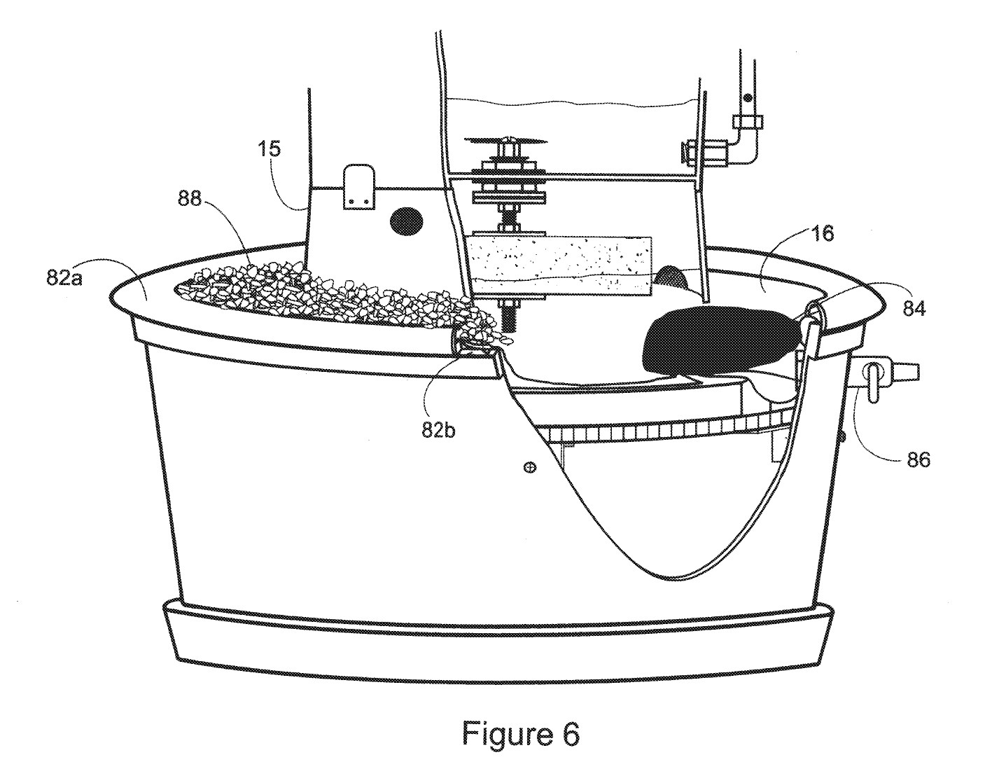

With reference to FIGS. 5b and 6, water from vessel 15 discharges through orifices or openings 80 in the side wall of the vessel into tray or watering station 16 which defines the upper wall of the base. The tray has a rim 82a which prevents water from overflowing the tray. A notch 82b is formed in the rim for water to discharge from the tray should it be over-filled.

As has been explained above, the water feeder of the invention is composed of a number of individual vessels which are arranged one below another and that rain water flows through orifices from one vessel to the next in line. Since the orifices constricts the flow, there is turbulence in the water and this turbulence supplements the turbulence caused by the agitator. The turbulence caused by the orifices is produced entirely without the necessity of an external source of power to cause it.

To facilitate periodic cleaning of the tray, a depression 84 is provided so that the tray may be drained dry at that time through tap 86. The tap may be closed to prevent water in the tray from draining from the tray at other times.

If the water feeder of the invention is intended to provide water for bees, it is advisable to have a layer of gravel or stones 88 on the tray on which bees can rest while drinking to minimize the risk that they will drown at that time.

It will be understood that modifications can be made in the water feeder of the invention without departing from the scope and purview of the invention as defined in the appended claims.

I claim:

1. A portable water feeder including: a collector for rain water; a filter for removing impurities from the rain water so collected to provide filtered, water; a vessel for holding the filtered water; an agitator for maintaining the filtered water in motion in said vessel; a watering station to which the filtered water flows from said vessel; and a valve for controlling the quantity of water which flows from said vessel to said watering station.

2. The water feeder of claim 1 wherein said collector includes a cylindrical side wall and an open top from which said filter projects upwardly, said filter being a screen which tapers upwardly for collecting rain flowing horizontally, obliquely and vertically above said side wall.

3. The water feeder of claim 1 wherein said, agitator includes an array of cones which radiate from a central rod, each said cone having an open inlet and a tapering side wall, said cones being oriented such that when located in a wind said cones are caused to rotate with resulting rotation of said rod; and a blade within said vessel and caused to rotate by said rotating rod with resulting agitation of the water.

4. A portable water feeder including: a collector for rain water; a filter for removing impurities from the rain water so collected to provide filtered water; a plurality of vessels arranged one below another beneath said collector and being in fluid flow communication with one another, an orifice between each adjacent pair of said vessels through which water flows and arranged such that the water flows downwardly through each said orifice commencing at said collector and settling at a watering station; an agitator for maintaining the water in motion; and a valve for controlling the quantity of water which settles in said watering station.

5. The water feeder of claim 4 wherein said collector includes a cylindrical side wall and an open top from which said filter projects upwardly, said filter being a screen which tapers upwardly for collecting rain flowing horizontally, obliquely and vertically above said side wall.

6. The water feeder of claim 4 wherein said agitator includes an array of cones which radiate from a central rod, each said cone having an open inlet and a tapering side wall, said cones being oriented such that when located in a wind said cones cause said rod to rotate; and a blade within said vessel and caused to rotate by said rotating rod with resulting agitation of the water.

7. The water feeder of claim 4 wherein said vessels are arranged and constructed to restrict all flow of water between adjacent said vessels to water which flows through said orifice between said adjacent vessels.

8. The water feeder of claim 7 wherein said collector includes a cylindrical side wall and an open top from which said filter projects upwardly, said filter being a screen which tapers upwardly for collecting rain flowing horizontally, obliquely and vertically above said side wall.

9. The water feeder of claim 7 wherein said agitator includes an array of cones which radiate from a central rod, each said cone having an open inlet and a tapering side wall, said cones being oriented such that when located in a wind, said cones cause said rod to rotate; and a blade within said vessel and caused to rotate by said rotating rod with resulting agitation of the water.
